(19) United States
(12) Patent Application Publication
(10) Pub. No.: US 2011/0054087 A1
(43) Pub. Date: Mar. 3, 2011

(54) Flame-Retardant cyanate esters

(76) Inventors: Vilas M. Chopdekar, Edison, NJ (US); Angelo R. Mellozzi, North Plainfield, NJ (US); Arthur T. Cornelson, Manville, NJ (US)

(21) Appl. No.: 12/660,764

(22) Filed: Mar. 4, 2010

Related U.S. Application Data
(63) Continuation-in-part of application No. 11/446,322, filed on Jun. 3, 2006, now abandoned.
(60) Provisional application No. 60/690,778, filed on Jun. 15, 2005.

(51) Int. Cl. C08K 5/5313; C07F 9/32; C09K 21/12

(52) U.S. Cl. 524/110; 558/82; 252/609

(57) ABSTRACT

A phosphorus-containing cyanate ester which imparts flame retardance to polymers, e.g., thermosetting polymers such as epoxies, with which it is admixed. The resultant polymers are especially useful for electronic, aerospace and automotive applications. The phosphorus-containing cyanate esters have the structure (I):

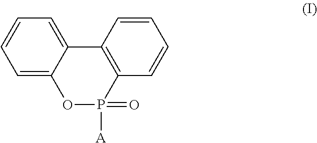

wherein A is a phenyl or naphthyl moiety containing a monocyanato or dicyanato substituent which may be further substituted with one or more of the same or dissimilar straight-chain, branched-chain or cycloalkyl groups having 1 to 12 carbon atoms. Preferably the phosphorus-containing cyanate ester will have structure (II) or structure (III):

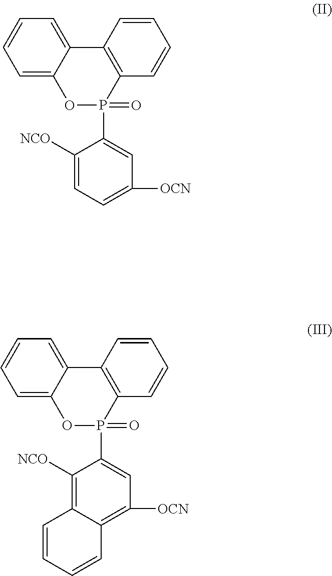

### CROSS REFERENCE TO RELATED APPLICATIONS

This application claims priority of Utility application Ser. No. 11/446,322, filed Jun. 3, 2006 which in turn claims priority of Provisional Application Ser. No. 60/690,778 filed Jun. 15, 2005, the disclosures of which are incorporated herein in their entirety.

### FIELD OF THE INVENTION

The present invention relates to novel phosphorus-containing cyanate esters and their use in imparting flame retardance to polymeric materials.

### BACKGROUND OF THE INVENTION

Thermoplastic and thermosetting polymers employed for building materials and textiles are required to have flame retardance. The problem of imparting flame retardance to such polymers is particularly critical in the case of polymers having aerospace and automotive applications, e.g., aircraft, spacecraft, high temperature radomes/antennae, radar transparent structures, missiles, aircraft engines, rocket nozzles, etc., as well as those employed in the fabrication of electronic devices, e.g., printed circuit boards, encapsulated integrated circuits, electronic connectors, etc. In addition to the requirements of good flame retardance, polymers employed in the fabrication of electronic devices must have excellent electrical characteristics, thermal stability and dimensional stability. It is extremely important that a flame retardant incorporated in the polymer of choice will not adversely affect the foregoing properties.

Halogen-containing materials are known for use in imparting flame retardance to such polymers, but have been found to be unsatisfactory since they result in the formation of toxic fumes (e.g., HCl, HBr, etc.), corrosion, dioxin contamination, etc. Organic phosphorus compounds have been widely used as halogen-free flame retardants. For example, aliphatic and aromatic phosphates have been used as replacements for halogen-containing flame retardants, e.g., triphenylphosphate, tricresylphosphate, triethylphosphate, etc. However, such organic phosphates are also undesirable since, after their incorporation into the polymer of choice, may cause defects such as reduced thermal stability and undesirable high migration.

The foregoing problems with the use of halogenated flame retardants and organic phosphate flame retardants have been overcome by the use of the phosphorus-containing cyanate esters of the invention for imparting flame retardance to polymers, particularly polymers employed in the fabrication of electronic devices of the type mentioned above.

### DETAILS OF THE INVENTION

The novel phosphorus-containing cyanate esters of the invention have the structure (I):

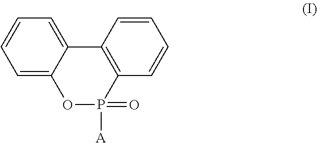

wherein A is a phenyl or naphthyl moiety containing a monocyanato or dicyanato substituent which may be further substituted with one or more of the same or dissimilar straight-chain, branched-chain or cycloalkyl groups having 1 to 12 carbon atoms.

Preferably, the phenyl or naphthyl moiety will contain a dicyanato substituent. Particularly preferred phosphorus-containing cyanate esters have the structure (II) or structure (III):

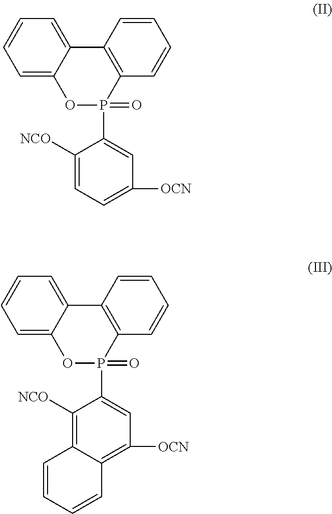

Preferred cyanate esters of the invention are methylphosphonic acid-3-[(3-cyanatophenoxy)-methyl-phosphinoylox]phenylester-3-cyanato-phenyl ester, 2-(6-oxido-6H-dibenz(c,e)(1,2)oxaphsphorin-6-yl)-1,4-benzene-dicyanate ester and 10(1,4-dicyanatonaphthyl)10H-9oxa-10-phosphananthrene-10-oxide.

Also useful are mixtures of a phosphorus-containing ester of the invention and a nonhalogenated cyanate ester containing no phosphorus. Such mixtures will typically contain about 5 to about 50 wt. % of the phosphorus-containing cyanate ester, based on the weight of the mixture. Suitable examples of the nonhalogenated cyanate ester containing no phosphorus are bisphenol M cyanate ester; dicyclopentadienylbisphenol cyanate ester; bisphenol A cyanate ester; tetramethylbisphenol F cyanate ester; bisphenol E cyanate ester; and phenol novolac cyanate ester.

The cyanate esters of the invention will generally be prepolymerized by heating at a temperature in the range of about 120 to about 200° C. for about 10 minutes to about 4 hours. The resultant prepolymer may then be admixed with the polymer of choice, typically a thermosetting polymer such as an epoxy resin and the mixture further polymerized by processes well known in the prior art. For economy purposes, it is preferred that the novel cyanate esters of the invention first be admixed with a nonhalogenated cyanate ester not containing any phosphorus such as those listed above and the admixture then subjected to pre-polymerization at a temperature in the range of about 120 to about 200° C. for about 10 minutes to about 4 hours. The mixture of prepolymerized cyanate esters is then admixed with the polymer of choice, further polymerized and fabricated into the desired article by processes well known in the prior art.

In general, the final polymeric mixture will consist of about 90 to about 99 wt. % of the polymer of choice, the balance being the phosphorus-containing cyanate ester prepolymer or a prepolymer mixture of the phosphorus-containing cyanate ester and a nonhalogenated cyanate ester not containing any phosphorus. Preferably, the phosphorus-containing cyanate esters of the invention are utilized to impart flame retardance to thermosetting polymers such as polyesters, bis-maleimides, polyimides, polyurethanes, epoxies and mixtures thereof.

The process for preparing the phosphorus-containing cyanate esters of the invention is straightforward and utilizes a phosphorus-containing monohydroxy or dihydroxy organic compound, a cyanogen halide and triethylamine. The organic compound will have the following structure (IV):

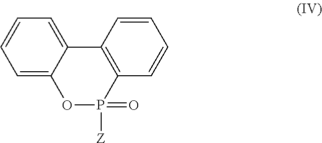

wherein Z is a phenyl or naphthyl moiety containing a monohydroxy or dihydroxy substituent which may be further substituted with one or more of the same or dissimilar straight-chain, branched-chain or cycloalkyl groups having 1 to 12 carbon atoms.

Preferably, the phenyl or naphthyl moiety will contain a dihydroxy substituent. Particularly preferred phosphorus-containing cyanate esters have the structures (V) and (VI):

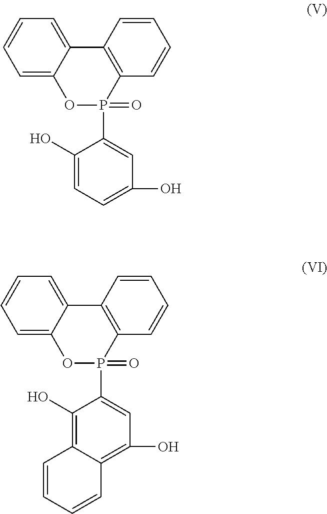

The selected phosphorus-containing monohydroxy organic compound is reacted with at least 1.0, preferably 1.05 to 1.30, moles of each of the cyanogen halide and triethylamine, per mole of the phosphorus-containing monohydroxy organic compound or at least 2.0, preferably 2.05 to 2.30 moles, each of the cyanogen halide and triethylamine, in the case of the dihydroxy organic compound. The reaction is conducted at a temperature in the range of about −50 to about 10° C. and a nonreactive solvent such as acetone is used to facilitate the reaction. Typically, the phosphorus-containing monohydroxy or dihydroxy organic compound, cyanogen bromide and the nonreactive solvent (present in an amount of about 3 to about 6 parts by weight per part of the phosphorus-containing monohydroxy or dihydroxy organic compound) are stirred together and the mixture is chilled to the selected reaction temperature. Thereafter, a solution of the triethylamine in about 2 to about 5 parts of the reactive solvent is slowly added, while stirring, to the reaction mixture over a period of about 20 minutes to about 2 hours. Stirring is continued, while maintaining the selected reaction temperature for an additional 1-4 hours and the reaction mixture is then allowed to slowly warm up to room temperature.

The phosphorus-containing cyanate ester is recovered from the reaction mixture by extraction with a solvent such as methylene chloride (about 0.5 to about 2 parts per part of the reaction mixture), and the solvent extract is washed several times with water to remove any unreacted components and byproducts. The phosphorus-containing cyanate ester is then recovered from the solvent extract by evaporation of the solvent. Typically, the yield of the phosphorus-containing cyanate ester will range from about 95 to about 99%.

Representative examples of useful phosphorus-containing monohydroxy or dihydroxy organic compounds include 2-(6-oxide-6H-dibenz(c,e)oxa-phosphorin-6-yl-1,4-benzenediol; methylphosphonic acid-3-[(3-hydroxy-phenoxy)-methyl-phosphinoyloxa]phenylester-3-hydroxyphenyl ester; and 10(1,4-dihydroxy-naphthyl)10H-9-oxa-10-phosphaphenanthrene-10-oxide.

The following nonlimiting examples shall serve to illustrate the various embodiments of the invention; unless otherwise indicated, all parts and percentages are on a weight basis.

### Example 1

### Preparation of the Phosphorus-Containing Cyanate Ester

A one-liter, 4-necked flack was set up with a stirrer, condenser, nitrogen gas blanket and thermometer. The flask was placed in a dry ice-acetone bath having a temperature of −30 to −50° C. To the flask were added 41.8 g (0.1 mole) of methylphosphonic acid-3-[(3-hydroxy-phenoxy)-methyl-phosphinoyl-oxa]phenyl-ester-3-hydroxyphenyl ester, 225 g of acetone and 22.8 g (0.215 mole) of cyanogen bromide. The reaction mixture was stirred for several minutes and thereafter a solution of 21.6 g (0.215 mole) of triethylamine in 50 g of acetone were slowly added, with stirring, to the reaction mixture over a period of 45 minutes. The reaction mixture was then stirred for an additional 2 hours while maintaining a reaction temperature of −30 to −50° C. The dry ice-acetone bath was then removed and the reaction mixture was continued to be stirred and allowed to warm up to room temperature. 200 ml of methylene chloride and 200 ml of water were then added, with stirring, to the reaction mixture. Stirring was discontinued and the lower phase, i.e., the methylene chloride solution of the reaction product was removed and the upper aqueous phase was discarded. The lower phase was washed with three 200 ml portions of water to remove any unreacted components and byproducts and the resultant lower phase was then evaporated to dryness using a rotary evaporator under reduced pressure and at a temperature of 90° C. 46.1 g (98.5% yield) of the product consisting of methylphosphonic acid-3-[(3-cyanatophenoxy)-methyl-phosphinoyloxa]phenyl-ester-3-cyanatophenyl ester were obtained. This product was then converted to a prepolymer in admixture with a cyanate ester not containing any phosphorus as set forth in Example 2 below.

### Example 2

### Preparation and Evaluation of Flame Retardance of Prepolymer

30 g of methylphosphonic acid-3-[(3-cyanatophenoxy)-methylphosphinoyl-oxa]phenyl-ester-3-cyanatophenyl ester prepared by the procedure set forth in Example 1 were mixed with 30 g of bisphenol A cyanate ester and the mixture was heated to 150-152° C. for a period of 2 hours. The mixture was cooled to room temperature; it was noted that the mixture was a sticky, brown, viscous liquid and weighed 58 g (96.7% yield).

A 1 g sample of the sticky, brown, viscous liquid was placed was placed in an aluminum pan and a propane torch was applied to the sample. Although the sample burned, the flame was totally extinguished as soon as the torch was removed, thus indicating that the methylphosphonic acid-3-[(3-cyanatophenoxy)-methylphosphinoyloxa]phenylester-3-cyanato-phenyl ester had excellent flame retardant properties.

Further evaluations were carried out as follows: bisphenol A cyanate ester was prepolymerized by heating to a temperature of 150-152° C. for a period of 2 hours. The resultant prepolymer was then mixed with 200 ppm of cobalt acetyl acetonate catalyst and the mixture was placed in a dish which in turn was placed in an oven preheated to 150° C. and the temperature of the oven was increased to 200° C. and held at such temperature for one hour. The dish was then removed from the oven and cooled to room temperature. The resultant product was then cut into ¼ by ¼ inch pieces and used for testing. Testing was carried out by holding the pieces in a flame for 5 seconds. After 5 seconds, the flame was removed and observations immediately after removal of the flame were recorded. This procedure was repeated using mixtures of the prepolymer with varying amounts of the flame retardant cyanate ester (“F.R. Cyanate Ester”), i.e., methylphosphonic acid-3-[(3-cyanatophenoxy)-methylphosphinoyl-oxa]phenyl-ester-3-cyanatophenyl ester prepared by the procedure set forth in Example 1 above. The results are summarized in Table I below.

TABLE I

| bisphenol A cyanate | F.R. Cyanate | Observation immediately |
|---|---|---|
| ester prepolymer | Ester | after removal of the flame |
| 100% | 0 | strong flame |
| 90% | 10% | weak flame extinguished in 5 |
| | | seconds |
| 67% | 33% | weak flame extinguished in 5 |
| | | seconds |
| 50% | 50% | No flame |

### Example 3

### Bisphenol a Cyanate Ester & Hydroxy-Terminated Polybutadiene

### Example 3A

A one-liter resin flask was set up with a stirrer, heating mantle and thermometer. Into the flask were placed 375 g of bisphenol A cyanate ester, 125 g of hydroxy-terminated polybutadiene. The reaction mixture was heated, with stirring to 160-165° C., and maintained at such temperature for two hours to initiate prepolymer formation. Thereafter, the reaction mixture was cooled to 100° C., and 167 g of methyl ethyl ketone were slowly added to the prepolymer to obtain a prepolymer solution.

### Example 3B

Ten g (7.5 g of active prepolymer) of the prepolymer solution prepared in Example 3A were used as is (Sample I) or were mixed with 2.5 g (Sample II) of the phosphorus-containing cyanate ester prepared in Example 1 or 13.3 g of the pre-polymer solution and 1.1 g (Sample III) of the phosphorus-containing cyanate ester prepared in Example 1 were each placed in an aluminum dish. Cobalt acetyl acetonate catalyst (200 ppm) was added to the samples which were then each heated at 150° C. for two hours and then at 200° C. for one hour to cure the polymer. Each dish was then removed from the oven and cooled to room temperature. The resultant product was then cut into ¼ by ¼ inch pieces and used for testing. Testing was carried out by holding the pieces in a flame for 5 seconds. After 5 seconds, the flame was removed and observations immediately after removal of the flame were recorded. The results are summarized in. Table II:

TABLE II

| | | Observation immediately |
|---|---|---|
| Sample | Description | after removal of the flame |
| I | 10 g of Example 3A | Strong flame burning >30 sec. |
| II | 10 g of Example 3A plus | Weak flame burning for 4 sec. |
| | 2.5 g of phosphorus-containing | |
| | cyanate ester | |
| III | 13.3 g of Example 3A plus | Weak flame burning for 7 sec. |
| | 1.1 g of phosphorus-containing | |
| | cyanate ester | |

### Example 4

### Epoxy Resin in Admixture with Prepolymer of Example 2

9 g of an epoxy resin were cured with an amine catalyst and the resultant cured epoxy polymer was subjected to a flame test as described above. The cured epoxy polymer exhibited a strong flame after removal of the flame and the burning continued for more than 30 seconds. This example was repeated with an admixture of 9 g of the epoxy resin, 3 g of the prepolymer of Example 2 and the amine curing catalyst. The admixture was then subjected to a flame test as described above. The admixture exhibited a weak flame for 8 seconds after the flame was removed.

### Example 5

### Prepolymer of Bisphenol a with Diphenylmethane Bismaleimide in Admixture with Flame Resistant Cyanate Ester of Example 1

A prepolymer was prepared by mixing 90 g of bisphenol A cyanate ester with 10 g of diphenylmethane bismaleimide and maintaining this mixture at 160° C. for 12 hours. The resultant prepolymer was then cooled and broken into pieces and thereafter subjected to a flame test as described above. The prepolymer exhibited a strong flame after removal of the flame and the burning continued for more than 15 seconds. This example was repeated with a polymer prepared from an admixture of 9 g of the prepolymer and 1 g of the fire retardant cyanate ester prepared as in Example 1. Cobalt acetyl acetonate catalyst (200 ppm) was added to the admixture which was then heated at 150° C. for two hours and subsequently at 200° C. for one hour to cure the polymer. The resultant cured polymer was then cooled and broken into pieces and thereafter subjected to a flame test as described above. The cured polymer exhibited a weak flame after removal of the flame and the burning continued for only 5 seconds.

### Example 6

### Cyanate Ester of Dihydroxyphosphonate and Bisphenol A

A one-liter, 4-necked flack was set up with a stirrer, condenser, nitrogen gas blanket and thermometer. The flask was placed in a dry ice-acetone bath having a temperature of −30 to −50° C. To the flask were added 39.2 g (0.09375 m) of dihydroxyphosphonate and 7.1 g (0.03125 m) of bisphenol-A. Thereafter, 205 g of acetone were added and the reaction mixture was stirred for 10 minutes to obtain a solution. 28.6 (0.27 m) of cyanogen bromide were added and the contents of the flask were cooled to −30° C. Thereafter, 27.6 g (0.27 m) of triethylamine in 60 g of acetone were added over 1.5 hours, while maintaining the reaction mixture at −30° C. (a white precipitate was obtained).

The reaction mixture was then stirred at −30° C. for an additional 2 hours and then was warmed to 15° C. Thereafter, 200 cc of methylene chloride were added and the reaction mixture was stirred for 5 minutes. 210 g of purified water were then added and the reaction mixture was stirred for 15 minutes. The top (aqueous) layer was removed by a separatory funnel and discarded. The bottom (methylene chloride) layer was washed 3 additional times with 210 g portions of purified water. The washed methylene chloride layer was placed in a rotary evaporator and the methylene chloride was stripped off under vacuum while in a water bath at 85° C.; and 49.5 g (94% yield) of product was obtained. The product was subjected to FTIR analysis and a strong band for the OCN moiety was observed.

5 g of the product were placed in an aluminum dish and 1 drop of cobalt acetonyl acetate was added. This mixture was then cured at 170° C. for 3 hours and then at 200° C. for an additional 3 hours. A yellowish clear film was then obtained. The film was then subjected to a flame test as described above, and it was observed that the film would not burn.

### Example 7

### Cyanate Ester of Bis(methylphosphanatoresorcinol)resorcinol and 3-n-pentadecadienyl resorcinol

A one-liter, 4-necked flack was set up with a stirrer, condenser, nitrogen gas blanket and thermometer. The flask was placed in a dry ice-acetone bath having a temperature of −30 to −50° C. To the flask were added 39.2 g (0.09375 m) of bis(methylphosphanato-resorcinol)resorcinol and 9.8 g (0.03125 m) of 3-n-pentadecadienylresorcinol. 205 g of acetone were then added and the reaction mixture was stirred for 15 minutes to obtain a solution. 28.6 g (0.27 m) of cyanogen bromide were added and the contents of the flask were cooled to −30° C. and stirred for 15 minutes. Thereafter, 27.6 g (0.27 m) of triethylamine in 60 g of acetone were added over 1 hour, while maintaining the reaction mixture at −30° C.

The reaction mixture was then stirred at −30° C. for an additional 2 hours and then was warmed to 15° C. Thereafter, 238 g of methylene chloride were added and the reaction mixture was stirred for 15 minutes. 170 g of purified water were then added and the reaction mixture was stirred for 15 minutes. The top (aqueous) layer was removed by a separatory funnel and discarded. The bottom (methylene chloride) layer was washed 3 additional times with 170 g portions of purified water. The washed methylene chloride layer was placed in a rotary evaporator and the methylene chloride was stripped off under vacuum while in a water bath at 90° C. 54.5 g (98.5% yield) of product was obtained.

5 g of the product were placed in an aluminum dish and 1 drop of cobalt acetonyl acetate was added. This mixture was then cured at 170° C. for 3 hours and then at 200° C. for an additional 3 hours. A tough clear film was then obtained. The film was then subjected to a flame test as described above, and it was observed that the flame was self-extinguishing after four seconds.

### Example 8

### Cyanate Ester of Bis(methylphosphanato-3-n-pentadeca-dienylresorcinol)-3-n-pentadecadienylresorcinol

A one-liter, 4-necked flack was set up with a stirrer, condenser, nitrogen gas blanket and thermometer. To the flask were added 66.75 g (0.062 m) of bis(methylphosphanato-3-pentadecadienylresorcinol) and 229 g of acetone. The contents of the flask were stirred at 20° C. for 30 minutes to get a clear solution. Thereafter, 14.3 g (0.135 m) of cyanogen bromide were added and the reaction mixture was stirred for 15 minutes to obtain a clear solution. The flask was then placed in a dry ice-acetone bath and the reaction mixture was cooled to −30° C. A mixture of 13.8 g (0.135 m) of triethylamine in 20 g of acetone was then added, with stirring, over a 30-minute period, while maintaining the contents of the flask at −30° C. The contents of the flask were stirred an additional 2 hours while maintaining the contents of the flask at −30° C. Thereafter, the dry ice-acetone bath was removed and the contents of the flask were allowed to warm up to 10-15° C. 250 g of methylene chloride were then added and the triethylamine hydrobromide salt byproduct was removed by washing the methylene chloride layer with four 180 g portions of water. The methylene chloride was then removed under vacuum by rotary evaporation at 90° C., yielding 69 g (98.7% yield) of a very thick oil.

5 g of the product were placed in an aluminum dish and 1 drop of cobalt acetonyl acetate was added. This mixture was then cured at 170° C. for 3 hours and then at 200° C. for an additional 3 hours. A tough clear film was then obtained which was then subjected to a flame test as described above, and it was observed that the flame was self-extinguishing after five seconds.

What is claimed is:

1. A phosphorus-containing cyanate ester having the structure (I): 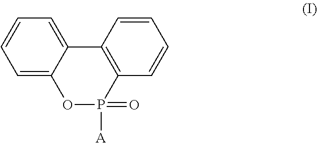
wherein A is a phenyl or naphthyl moiety containing a monocyanato or dicyanato substituent which may be further substituted with one or more of the same or dissimilar straight-chain, branched-chain or cycloalkyl groups having 1 to 12 carbon atoms.

2. The cyanate ester of claim 1 having the structure (II):

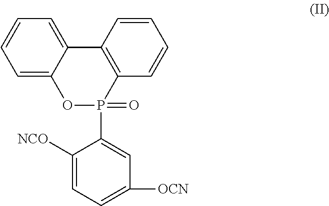

3. The cyanate ester of claim 1 having the structure (III):

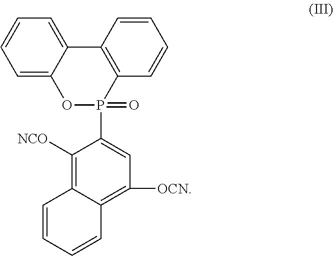

4. A mixture of the phosphorus-containing ester of claim 1 and a nonhalogenated cyanate ester containing no phosphorus.

5. The mixture of claim 4 wherein the phosphorus-containing ester is present in an amount of about 5 to about 50 wt. %, based on the weight of the mixture.

6. A mixture of the phosphorus-containing ester of claim 2 and a nonhalogenated cyanate ester containing no phosphorus.

7. The mixture of claim 6 wherein the phosphorus-containing cyanate ester is present in an amount of about 5 to about 50 wt. %, based on the weight of the mixture.

8. A mixture of the phosphorus-containing ester of claim 3 and a nonhalogenated cyanate ester containing no phosphorus.

9. The mixture of claim 8 wherein the phosphorus-containing cyanate ester is present in an amount of about 5 to about 50 wt. %, based on the weight of the mixture.

10. The mixture of claim 8 wherein the nonhalogenated cyanate ester containing no phosphorus is selected from the group consisting of bisphenol M cyanate ester; dicyclopentadienylbisphenol cyanate ester; bisphenol A cyanate ester; tetramethylbisphenol F cyanate ester; bisphenol E cyanate ester; and phenol novolac cyanate ester.

11. A mixture of the cyanate ester of claim 1 and a thermosetting polymer.

12. The mixture of claim 11 wherein the thermosetting polymer is selected from the group consisting of polyester, bis-maleimide, polyimide, polyurethane, epoxy and mixtures thereof.

13. The mixture of claim 11 wherein the cyanate ester is present in an amount of about 1 to about 10 wt. %, based on the weight of the mixture.

14. A mixture of the cyanate ester of claim 2 and a thermosetting polymer.

15. The mixture of claim 14 wherein the thermosetting polymer is selected from the group consisting of polyester, bis-maleimide, polyimide, polyurethane, epoxy and mixtures thereof.

16. The mixture of claim 14 wherein the cyanate ester is present in an amount of about 1 to about 10 wt. %, based on the weight of the mixture.

17. A mixture of the cyanate ester of claim 3 and a thermosetting polymer.

18. The mixture of claim 17 wherein the thermosetting polymer is selected from the group consisting of polyester, bis-maleimide, polyimide, polyurethane, epoxy and mixtures thereof.

19. The mixture of claim 17 wherein the cyanate ester is present in an amount of about 1 to about 10 wt. %, based on the weight of the mixture.

20. A method for preparing a phosphorus-containing cyanate ester having the structure (I): 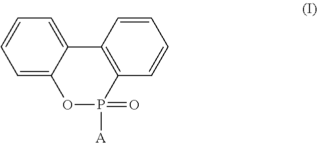
wherein A is a phenyl or naphthyl moiety containing a monocyanato or dicyanato substituent which may be further substituted with one or more of the same or dissimilar straight-chain, branched-chain or cycloalkyl groups having 1 to 12 carbon atoms which comprises reacting a monohydroxy or dihydroxy organic compound with a cyanogen halide and triethylamine, and thereafter recovering the resultant phosphorus-containing cyanate ester from the reaction mixture, said organic compound having the structure (IV): 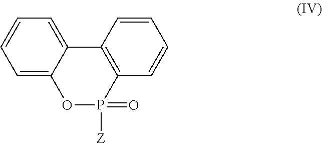
wherein Z is a phenyl or naphthyl moiety containing a monohydroxy or dihydroxy substituent which may be further substituted with one or more of the same or dissimilar straight-chain, branched-chain or cycloalkyl groups having 1 to 12 carbon atoms.

21. The method of claim 20 wherein the organic compound has the structure (V):

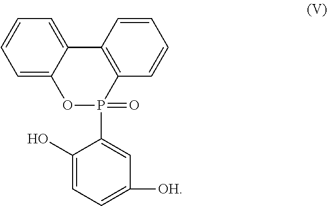

22. The method of claim 20 wherein the organic compound has the structure (VI):

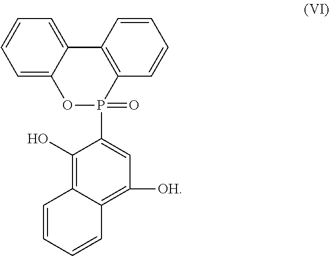

23. The method of claim 20 wherein the reaction is carried out in the presence of a nonreactive solvent at a temperature of about −50 to about 10° C.

24. The method of claim 23 wherein the solvent comprises acetone.
